(19) United States
(12) Patent Application Publication
(10) Pub. No.: US 2010/0139458 A1
(43) Pub. Date: Jun. 10, 2010

(54) COUPLING FOR HANDLE AND TOOL HEAD

(75) Inventors: JOSHUA O. MULLEN, Duncannon, PA (US); Eric D. Hyp, Harrisburg, PA (US)

Correspondence Address: ECKERT SEAMANS CHERIN & MELLOTT, 600 GRANT STREET, 44TH FLOOR, PITTSBURGH, PA, 15219, US

(73) Assignee: Ames True Temper, Inc., Camp Hill, PA (US)

(21) Appl. No.: 12/331,058

(22) Filed: Dec. 9, 2008

(51) Int. Cl. B25D 1/00; B65D 59/00; B25G 1/00

(52) U.S. Cl. 81/20; 403/12; 81/489

(57) ABSTRACT

A coupling for an elongated handle and a tool head is provided. The coupling may be positioned at the handle upper end after the handle upper end has passed through the tool head eye. The coupling is a frustoconical shape which engages the tool head in a manner of a slip eye coupling. However, because the lower end of the handle does not pass through the tool head eye, the lower end of the handle, i.e., the grip, may have any shape. Thus, the present invention allows for use of a slip eye coupling while also allowing the handle grip to be of any shape.

### BACKGROUND OF THE INVENTION

1. Field of the Invention

This invention relates to a coupling structured to join a handle and a tool head and, more specifically, to a slip eye coupling that negates the need for the grip end of the handle to pass through the tool head eye.

2. Background Information

Tools that are swung and/or impact a surface, such as, but not limited to, sledge hammers, mattocks, hatchets, and axes, must have a strong coupling between the tool head and the upper end of a handle. Typically, the tool head defines an opening, or eye, into which the handle upper end extends. Two primary coupling devices were used for such tools and were typically selected based on the shape of the handle grip. That is, on the end of the handle opposite the tool head, the handle has a grip. If the grip is small enough to pass through the tool head eye, the coupling device is typically a tapered handle upper end. This type of coupling is called a “slip eye” coupling. To couple the tool head to the handle, the handle was passed, grip first, through the eye from the upper side of the tool head. As the tapered upper end of the handle entered the eye, the wider portion of the handle engaged the inner surface of the eye, thereby coupling the handle to the tool head. An additional coupling device, such as an adhesive, may be used to prevent the tool head from moving downwardly on the handle. One advantage to this design is that it is almost impossible for the tool head to move upwardly over the coupling, which could be dangerous in mid-swing and/or at impact.

Of course, this design also required that the lower end of the handle be sized and/or shaped to pass through the tool head eye. Given that tool head eyes are relatively small compared to an ergonomically shaped grip, i.e., a grip shaped for comfortable use in an average user's hand, such handles were either too small, or, had a shaped grip disposed over the handle lower end after the handle was coupled to the tool head. When a grip was coupled to the handle, the grip was, typically held in place by an adhesive, or was molded about the handle lower end. As such, the addition of a grip was expensive and added to the time required to assemble the tool.

If, on the other hand, the handle lower end was sized and/or shaped to be a grip, then the lower end of the handle could not pass through the tool head eye. With this design, the coupling typically utilized an adhesive and/or a wedge disposed at the handle upper end. With this type of handle, the handle upper end was passed into the eye from the lower side of the tool head. Once the handle upper end was in the proper position, an epoxy or other adhesive was disposed between the handle and the tool head thereby securing the two components to each other. Alternatively, or in conjunction with an adhesive, the upper end of the handle could be locked into place with a wedge and/or a, typically, metal ring. That is, once the handle upper end was in the proper position within the tool head eye, a wedge/ring was driven into the handle upper face thereby dividing the handle upper end and compressing the portions against the tool head eye. Often, the tool head eye was tapered, wide at the top, narrow at the bottom, to accommodate the shape of the handle upper end after installation. An epoxy or other adhesive may have been used to fill any gaps between the handle and the tool head and/or to seal the wedge in position. However, there was a chance, especially after wear and tear had degraded the coupling, that the tool head could become decoupled from the handle and the tool head may move upwardly off the handle. It is further noted that inserting a wedge into a handle end typically introduces an intentional fracture/deformation into the handle material. Such a fracture/deformation will hasten the deterioration of the handle. However, as the lower end of the handle does not have to pass through the tool head eye, the handle grip could be formed/cut/molded into the original handle material and no additional grip needed to be added.

### SUMMARY OF THE INVENTION

The concept disclosed and claimed herein provides for a coupling for an elongated handle and a tool head wherein the coupling may be positioned at the handle upper end after the handle upper end has passed through the tool head eye. The coupling is a frustoconical shape which engages the tool head in a manner of a slip eye coupling. However, because the lower end of the handle does not have to pass through the tool head eye, the lower end of the handle, i.e., the grip, may have any shape. Thus, the present invention allows for use of a slip eye coupling while also allowing the handle grip to be of any shape.

Preferably, the coupling is a bifurcated body that, when the two halves are joined, has an inner surface defining a cavity and an outer surface having a frustoconical shape. After the upper end of the handle has been passed through the tool head eye, the two portions of the coupling body are positioned about the exposed handle upper end so that, when the two halves of the coupling body are joined the handle upper end is positioned within the coupling body cavity. When the handle is drawn back down through the tool head eye, the outer surface of the coupling body engages the tool head in the manner of a slip eye coupling. Preferably, the handle upper end has a mounting structured to be engaged by an anchor located in the coupling body cavity. Thus, the coupling resists slipping off the handle upper end, and the slip eye coupling joins the tool head and the handle.

The disclosed coupling also allows for improvements in the manufacturing and/or assembly process for tools. That is, when the handle upper end is sized to pass through the tool head eye, the former coupling device typically required an epoxy which needed to be cured or the coupling device would require a lengthy molding cycle to permanently mold the coupling to the handle upper end. Further, unlike the former slip eye couplings, wherein the lower end of the handle has a grip applied thereto, the disclosed coupling allows for the lower end of the handle to be formed/cut/molded into a grip. Thus, there is no need to apply an additional grip.

### BRIEF DESCRIPTION OF THE DRAWINGS

A full understanding of the invention can be gained from the following description of the preferred embodiments when read in conjunction with the accompanying drawings in which:

FIG. 1 is an isometric view of the preferred embodiment of the invention.

FIG. 2 is a cross-sectional view of an alternate embodiment.

FIG. 3 is a cross-sectional view of another alternate embodiment.

### DESCRIPTION OF THE PREFERRED EMBODIMENTS

As used herein, “coupled” means a link between two or more elements, whether direct or indirect, so long as a link occurs.

As used herein, “directly coupled” means that two elements are directly in contact with each other.

As used herein, “fixedly coupled” or “fixed” means that two components are coupled so as to move as one while maintaining a constant orientation relative to each other.

As used herein, the “upper” end of a tool handle is the end to which a tool head is attached. The “lower” end of the handle is the end opposite the tool head.

As used herein, “frustoconical” means any tapered three-dimensional shape having generally flat, parallel ends including, but not limited to, frustoelliptical.

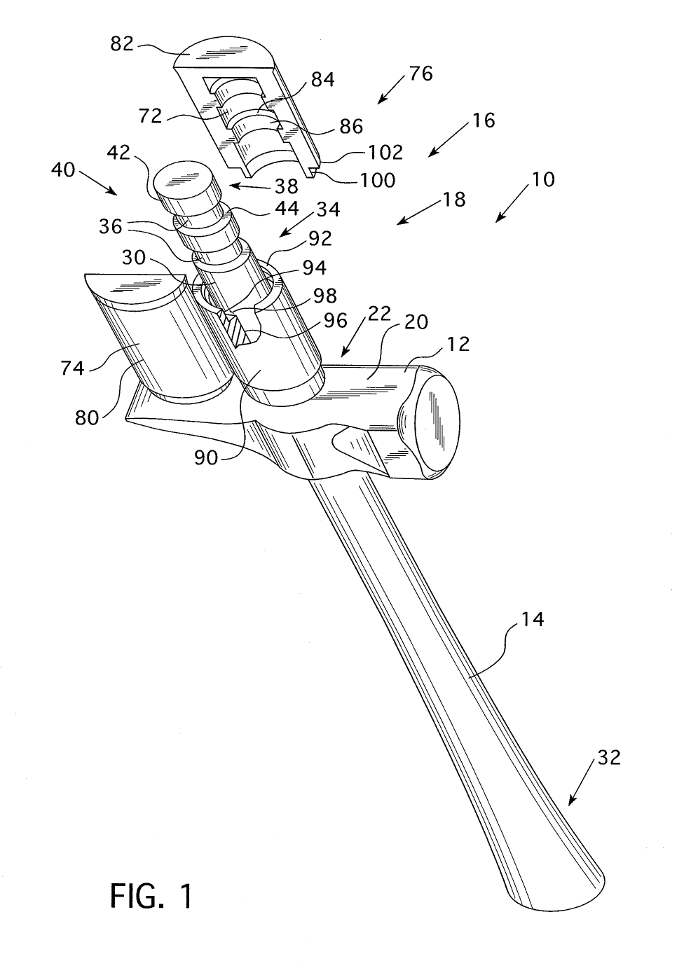

As shown in FIG. 1, a tool 10 includes a tool head 12, an elongated handle 14 and a coupling 16 that is a compressible collar assembly 18. The tool head 12 may be any type of tool head 12 but is preferably an impact tool head 12 such as, but not limited to a sledge hammer (as shown), mattock, hatchet, or an axe. The tool head 12 has a body 20 structured to perform a function, e.g. pound, cleave, dig, etc. which is not relevant to this invention. The tool head body 20 is made from a rigid and hard material, typically steel, that is, essentially, not deformable. The tool head 12 has an opening, hereinafter the “eye” 22, extending vertically through the tool head 12. The tool head eye 22 may have any cross-sectional shape.

The handle 14 has an upper end 30, and a lower end 32. The upper end 30 is sized and shaped to pass through the tool head eye 22. It is noted that, as the handle upper end 30 does not contact the tool head 12, the handle upper end 30 does not have to correspond to the shape of the tool head eye 22 and may have a conveniently manufactured shape such as, but not limited to, a generally cylindrical shape, as shown. The handle upper end 30 includes a mounting 34 that is structured to be engaged by the compressible collar assembly anchor device 76, discussed below. In the preferred embodiment, the mounting 34 is at least one (two shown) generally rectangular groove(s) 36 extending radially about the handle upper end 30. However, in the simplest form, as discussed below, the mounting 34 may be an engagement surface structured to create a frictional coupling between the mounting 34 and the compressible collar assembly anchor device 76. However, a frictional coupling is not preferred considering the stresses to which the tool 10 will be exposed. Another simple mounting 34, also discussed below, is merely a downwardly facing circumferential face 38 extending substantially about said handle upper end 30 and extending in a plane generally perpendicular to the longitudinal axis of the handle upper end 30. In the preferred embodiment having grooves 36, the downwardly facing circumferential face 38 is created on the handle 14 by providing a void 40. Where there is a void 40, the handle upper end 30 has a wide portion 42 and a narrow portion 44. That is, in the preferred embodiment, each groove 36 acts as a void wherein each upper surface of the groove 36 acts as the downwardly facing circumferential face 38. Further, the wide portion 42 is the portion of the handle 14 without the groove 36, and the narrow portion 44 is located at a groove 36.

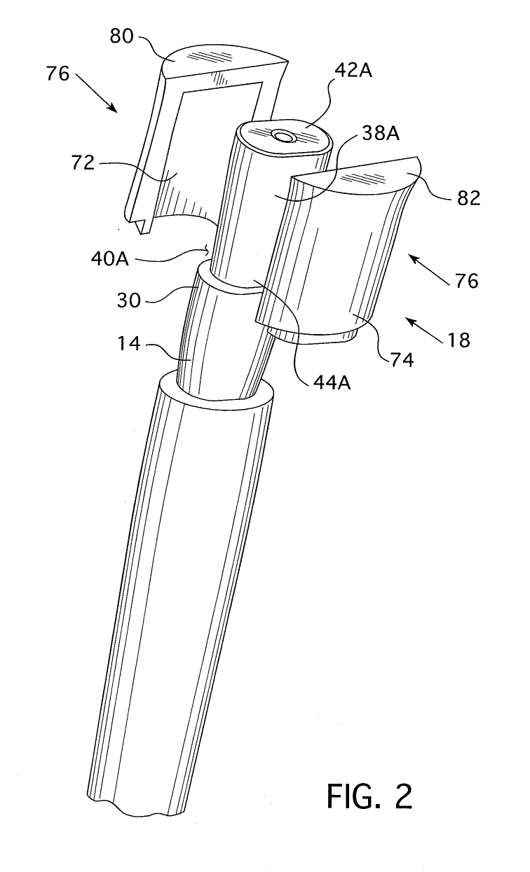

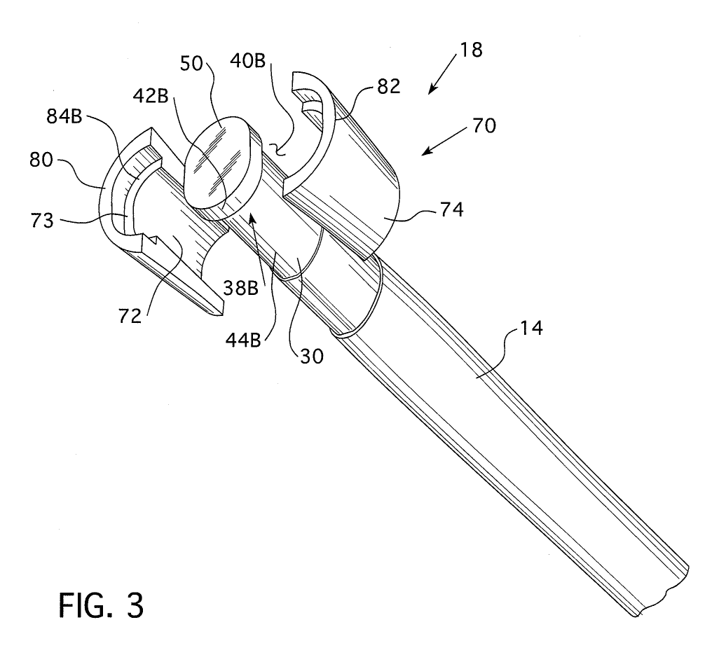

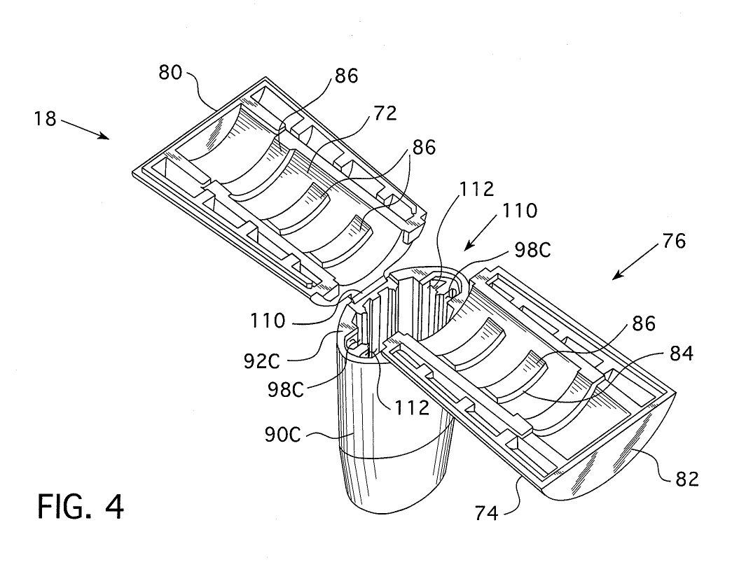

As shown in FIGS. 2-3, the void 40 and the circumferential face 38 may be created in a number of configurations. For example, as shown in FIG. 2, the handle upper end 30 has a frustoconical shaped void 40A having a downwardly facing circumferential face 38A. In this configuration, the wide portion 42A is the tip of the handle 14 and the narrow portion 44A is disposed at the bottom of the void 40A.

As shown in FIG. 3, the handle upper end 30 may include a cap 50 extending generally perpendicular to the longitudinal axis of the handle 14. In this embodiment, the void 40B is the area below the cap 50 and the downwardly facing circumferential face 38B is the bottom face of the cap 50. It is noted that in this embodiment and the preferred embodiment with the generally rectangular groove 36, the downwardly facing circumferential face 38, 38B extends generally perpendicular to the longitudinal axis of the handle 14. In the embodiment shown in FIG. 3, the void 40B is the area located below the overhanging cap 50. Thus, the handle wide portion 42B is the cap 50 and the handle narrow portion 44B is the area located below the overhanging cap 50.

The handle lower end 32 is sized and/or shaped so as to be larger than the tool head eye 22. That is, the handle lower end 32 cannot pass through the tool head eye 22. Preferably, the handle lower end 32 is shaped as a grip 60. The grip 60 may be formed, cut, or molded from the material used to make the handle 14. That is, there is no need for an additional element, e.g. a coating or a sleeve, to be disposed over the handle lower end 32. However, if such a coating or a sleeve is desired, e.g. to add a spongy grip 60, such components may be used.

The compressible collar assembly 18 includes a body 70 with an inner surface 72 defining a cavity and an external surface 74 defining a frustoconical shape, and an anchor device 76. Preferably, the compressible collar assembly body 70 includes a first member 80 and a second member 82 that are structured to be coupled together. The first member 80 and the second member 82 are structured to be coupled together while disposed about the handle upper end 30. Further, and as described below, the first member 80 and the second member 82 may be moved into their final position from opposite sides of the handle upper end 30. In this configuration, the handle upper end 30 is sized to be disposed within the cavity defined by the compressible collar assembly body inner surface 72. Preferably, the compressible collar assembly body inner surface 72 corresponds to the shape of the handle upper end 30, including any voids 40. Preferably, any portion of the compressible collar assembly body inner surface 72 that extends in a direction other than parallel to the longitudinal axis of the handle 14 acts as an anchor device 76. The anchor device 76 includes at least one anchor face 84 structured to engage the handle downwardly facing circumferential face 38. Preferably, the anchor face 84 and the handle downwardly facing circumferential face 38 are shaped to correspond to each other and, as such, when joined, the anchor face 84 and the handle downwardly facing circumferential face 38 engage each other in a face-to-face manner. Thus, in the preferred embodiment, the anchor device 76 includes at least one ridge 86 (two as shown) extending from the compressible collar assembly body inner surface 72. The at least one ridge 86 is shaped to correspond to the shape of the groove 36, i.e., in the preferred embodiment, the at least one ridge 86 and the corresponding groove 36 has a generally rectangular cross-section. The upper face of the at least one ridge 86 acts as the anchor face 84.

In the embodiment shown in FIG. 2, the compressible collar assembly body inner surface 72 is angled to correspond to the shape of the frustoconical shaped void 40A and is upwardly facing. In the embodiment shown in FIG. 3, the anchor face 84B is an upper surface 73 of the compressible collar assembly body 70B. That is, when the compressible collar assembly body 70B is disposed about the handle upper end 30, the compressible collar assembly body upper surface 73, which is the anchor face 84B, engages the bottom side of the cap 50 which is the downwardly facing circumferential face 38B.

In one preferred embodiment, the compressible collar assembly 18 may further include a mounting ring 90. The mounting ring 90 is sized to pass through the tool head eye 22. The mounting ring 90 has an upper face 92, a first inner surface 94, and a second inner surface 96. The first inner surface 94 is disposed adjacent to the upper face 92. The mounting ring second inner surface 96 is shaped to fit snugly about the handle upper end 30. The mounting ring first inner surface 94 is shaped to be spaced from the handle upper end 30. Thus, when the compressible collar assembly mounting ring 90 is disposed on the handle upper end 30, a hollow 98 is created between the handle upper end 30 and the mounting ring second inner surface 96. This hollow 98 is disposed adjacent to the compressible collar assembly mounting ring upper face 92. When a mounting ring 90 is utilized, the compressible collar assembly body 70 includes an axial extension 100 extending from the compressible collar assembly body lower end 102. The axial extension 100 extends in a direction generally parallel to the handle 14 longitudinal axis. The axial extension 100 is sized to be disposed within the compressible collar assembly mounting ring hollow 98.

In another preferred embodiment, shown in FIG. 4, the compressible collar assembly 18 and the mounting ring 90C are created as a unitary body wherein the two compressible collar assembly body members 80, 82 are coupled to the mounting ring 90C by living hinges 110. The two compressible collar assembly body members 80, 82 are substantially similar to the embodiment described above, but are shown with three ridges 86 on the inner surface 72. The living hinges 110 are disposed at the top of the mounting ring 90C. Accordingly, unlike the embodiment described above, the hollow 98C does not extend about the entire mounting ring 90C. That is, a portion of the mounting ring upper face 92C is formed into the two living hinges 110. Thus, the hollow 98C is reduced to two pockets 112 disposed about the periphery of the mounting ring upper face 92C.

The tool 10 is assembled as follows. The handle 14 is passed through the tool head eye 22 from the lower side of the tool head 12 until the handle upper end 30 is exposed. The two compressible collar assembly body members 80, 82 are brought together from opposite sides of the handle 14 so that the compressible collar assembly body 70 is disposed about the handle upper end 30 with the handle upper end 30 in the cavity defined by the compressible collar assembly body inner surface 72. When the two compressible collar assembly body members 80, 82 are brought together, the handle downwardly facing circumferential face 38 engages the compressible collar assembly anchor face 84 in a face-to-face manner. The engagement of the handle downwardly facing circumferential face 38 engages the compressible collar assembly anchor face 84 to generally prevent the compressible collar assembly 18 from moving axially on the handle 14. Thus, in the preferred embodiment, the at least one ridge 86 is moved into the at least one groove 36 as the compressible collar assembly body members 80, 82 are brought together. In this configuration, the upper face of the at least one ridge 86 engages the downwardly facing face 38 of the at least one groove 36.

Once the compressible collar assembly body 70 is in position, the handle 14 is drawn downwardly through the tool head eye 22. As the compressible collar assembly body 70 enters the tool head eye 22, the compressible collar assembly body external surface 74 engages, and binds against, the tool head body 20. Preferably, the compressible collar assembly body 70 is made from a substantially rigid, but slightly compressible, material such as, but not limited to, a thermoplastic or thermoset resin. Thus, the compressible collar assembly body 70 may deform slightly and be held by friction within the tool head body 20. Typically, a machine capable of applying a force of about 2500 lbs/psi is used to draw the handle 14 downwardly through the tool head eye 22. This force is sufficient to fix the compressible collar assembly body 70 within the tool head body 20. Further, due to the frustoconical shape of the compressible collar assembly body external surface 74, as the compressible collar assembly body 70 is drawn into the tool head eye 22, the compressible collar assembly body inner surface 72 is biased into the handle 14.

If the compressible collar assembly mounting ring 90 is used, the assembly is as follows. The compressible collar assembly mounting ring 90 is disposed on the handle 14 at a location below the handle upper end 30. The handle 14 is passed through the tool head eye 22 from the lower side of the tool head 12 until the handle upper end 30 and the compressible collar assembly mounting ring 90 are exposed. The two compressible collar assembly body members 80, 82 are brought together from opposite sides of the handle 14 so that the compressible collar assembly body 70 is disposed about the handle upper end 30 with the handle upper end 30 in the cavity defined by the compressible collar assembly body inner surface 72. Further, the compressible collar assembly body axial extension 100 is disposed within the mounting ring hollow 98. In this configuration, the compressible collar assembly mounting ring 90 generally holds the compressible collar assembly body 70 in position on the handle upper end 30. Having the compressible collar assembly body 70 held in position is useful during assembly as it allows the partially assembled tool 10 to be moved and reoriented. As before, the engagement of the handle downwardly facing circumferential face 38 engages the compressible collar assembly anchor face 84 to generally prevent the compressible collar assembly 18 from moving axially on the handle 14. Once the compressible collar assembly body 70 is in position, the handle 14 is drawn downwardly through the tool head eye 22. As the compressible collar assembly body 70 enters the tool head eye 22, the compressible collar assembly body external surface 74 engages, and binds against, the tool head body 20.

Thus, the compressible collar assembly 18 allows the assembly of a tool 10 with a handle having a lower end 32 that is larger than the tool head eye 22, but which does not rely upon an epoxy or other adhesive to couple the handle 14 to the tool head 12. Thus, during assembly there is not an extensive cure, or mold cycle, time. Further, because no wedge is used to reshape the handle upper end 30, the handle upper end 30 is not fractured or otherwise deformed.

While specific embodiments of the invention have been described in detail, it will be appreciated by those skilled in the art that various modifications and alternatives to those details could be developed in light of the overall teachings of the disclosure. For example, the groove 36 disclosed above is shown and described as being a generally rectangular groove 36; however the groove 36 could have any shape including, but not limited to, “V” shaped and arcuate. Further, it is noted that the two compressible collar assembly body members 80, 82 may be held in position on the handle upper end 30 by an adhesive. Such an adhesive is only used to maintain the compressible collar assembly body 70 in position during assembly and does not substantially adhere the compressible collar assembly body 70 to the tool head body 20. Accordingly, the particular arrangements disclosed are meant to be illustrative only and not limiting as to the scope of invention which is to be given the full breadth of the claims appended and any and all equivalents thereof.

What is claimed is:

1. A coupling for an elongated handle and a tool head, said tool head having an eye therethrough, said handle having a upper end sized to pass through said tool head eye, said handle upper end having a mounting structured to be engaged by an anchor device, said coupling comprising:
a compressible collar assembly having a body with an inner surface defining a cavity and an external surface defining a frustoconical shape, and an anchor device;
said inner cavity sized to accommodate said handle upper end; and
said anchor device structured to engage said handle upper end mounting and to resist axial movement of the compressible collar assembly relative to said handle upper end.

2. The coupling of claim 1 wherein said compressible collar assembly body includes a first member and a second member, said first member and a second member structured to be coupled together while disposed about said handle upper end.

3. The coupling of claim 2 wherein said handle upper end mounting includes at least one narrow portion of said handle upper end and at least one wide portion of said handle upper end, and wherein said compressible collar assembly anchor device includes a cavity inner surface shaped to correspond to the shape of said handle upper end mounting.

4. The coupling of claim 3 wherein said handle upper end mounting at least one wide portion includes a circumferential face extending substantially about said handle upper end, and wherein said compressible collar assembly anchor device includes at least one anchor face structured to engage said handle upper end mounting circumferential face in a generally face-to-face manner.

5. The coupling of claim 4 wherein said handle upper end mounting circumferential face extends in a plane that is generally perpendicular to the longitudinal axis of said handle, and wherein said compressible collar assembly anchor device anchor face extends in a plane that is generally perpendicular to the longitudinal axis of said handle.

6. The coupling of claim 4 wherein said handle upper end mounting circumferential face is part of at least one groove extending substantially about said handle upper end, and wherein:
said compressible collar assembly anchor device includes at least one ridge extending from said compressible collar assembly body inner surface; and
said compressible collar assembly anchor device at least one ridge includes said compressible collar assembly anchor device anchor face and said compressible collar assembly anchor device at least one ridge is sized to be disposed within said handle upper end mounting groove.

7. The coupling of claim 6 wherein said handle upper end mounting circumferential face extends in a plane that is generally perpendicular to the longitudinal axis of said handle and wherein said compressible collar assembly anchor device at least one ridge has a generally rectangular cross-section.

8. The coupling of claim 7 wherein:
said compressible collar assembly further includes a mounting ring, said mounting ring sized to pass through said tool head eye, said mounting ring having an upper face, a first inner surface, and a second inner surface, said first inner surface adjacent to said upper face;
said compressible collar assembly mounting ring second inner surface shaped to fit snugly about said handle upper end;
said compressible collar assembly mounting ring first inner surface shaped to be spaced from said handle upper end;
whereby, when said compressible collar assembly mounting ring is disposed on said handle upper end, a hollow is created between said handle upper end and said compressible collar assembly mounting ring second inner surface, said hollow being disposed adjacent to said compressible collar assembly mounting ring upper face; and
said compressible collar assembly body having a lower end, said lower end having an axial extension, said axial extension extending in a direction generally parallel to said handle axis, said axial extension sized to be disposed within said compressible collar assembly mounting ring hollow.

9. The coupling of claim 8 wherein said collar assembly body first member and second member are each coupled to said mounting ring by a living hinge.

10. The coupling of claim 1 wherein said compressible collar assembly does not include an adhesive structured to couple said handle to said tool head.

11. The coupling of claim 1 wherein said compressible collar assembly is coupled to said handle upper end without fracturing said handle upper end.

12. A tool comprising:
a tool head having an eye therethrough;
a handle having an upper end sized to pass through said tool head eye, said handle upper end having a mounting structured to be engaged by an anchor device;
a compressible collar assembly structured to couple said tool head and said handle, said compressible collar assembly having a body with an inner surface defining a cavity and an external surface defining a frustoconical shape, and an anchor device;
said inner cavity sized to accommodate said handle upper end; and
said anchor device structured to engage said handle upper end mounting and to resist axial movement of the compressible collar assembly relative to said handle upper end.

13. The tool of claim 12 wherein said compressible collar assembly body includes a first member and a second member, said first member and a second member structured to be coupled together while disposed about said handle upper end.

14. The tool of claim 13 wherein:
said handle upper end mounting includes at least one narrow portion of said handle upper end and at least one wide portion of said handle upper end; and
said compressible collar assembly anchor device includes a cavity inner surface shaped to correspond to the shape of said handle upper end mounting.

15. The tool of claim 14 wherein:
said handle upper end mounting at least one wide portion includes a circumferential face extending substantially about said handle upper end; and
said compressible collar assembly anchor device includes at least one anchor face structured to engage said handle upper end mounting circumferential face in a generally face-to-face manner.

16. The tool of claim 15 wherein:
said handle upper end mounting circumferential face extends in a plane that is generally perpendicular to the longitudinal axis of said handle; and
said compressible collar assembly anchor device anchor face extends in a plane that is generally perpendicular to the longitudinal axis of said handle.

17. The tool of claim 15 wherein:
said handle upper end mounting circumferential face is part of at least one groove extending substantially about said handle upper end;
said compressible collar assembly anchor device includes at least one ridge extending from said compressible collar assembly body inner surface; and
said compressible collar assembly anchor device at least one ridge includes said compressible collar assembly anchor device anchor face and said compressible collar assembly anchor device at least one ridge is sized to be disposed within said handle upper end mounting groove.

18. The tool of claim 17 wherein:
said handle upper end mounting circumferential face extends in a plane that is generally perpendicular to the longitudinal axis of said handle; and
said compressible collar assembly anchor device at least one ridge has a generally rectangular cross-section.

19. The tool of claim 18 wherein:
said compressible collar assembly further includes a mounting ring, said mounting ring sized to pass through said tool head eye, said mounting ring having an upper face, a first inner surface, and a second inner surface, said first inner surface adjacent to said upper face;
said compressible collar assembly mounting ring second inner surface shaped to fit snugly about said handle upper end;
said compressible collar assembly mounting ring second inner surface shaped to be spaced from said handle upper end;
whereby, when said compressible collar assembly mounting ring is disposed on said handle upper end, a hollow is created between said handle upper end and said compressible collar assembly mounting ring second inner surface, said hollow being disposed adjacent to said compressible collar assembly mounting ring upper face; and
said compressible collar assembly body having a lower end, said lower end having an axial extension, said axial extension extending in a direction generally parallel to said handle axis, said axial extension sized to be disposed within said compressible collar assembly mounting ring hollow.

20. The tool of claim 19 wherein said collar assembly body first member and second member are each coupled to said mounting ring by a living hinge.

21. The tool of claim 12 wherein said compressible collar assembly does not include an adhesive structured to couple said handle to said tool head.

22. The tool of claim 12 wherein said compressible collar assembly is coupled to said handle upper end without fracturing said handle upper end.
